(19) United States
(12) Patent Application Publication
(10) Pub. No.: US 2009/0077024 A1
(43) Pub. Date: Mar. 19, 2009

(54) SEARCH SYSTEM FOR SEARCHING A SECURED MEDICAL SERVER

(76) Inventors: Klaus Abraham-Fuchs, Erlangen (DE); Sultan Haider, Erlangen (DE); Georg Heidenreich, Erlangen (DE); Volker Schmidt, Mohrendorf (DE); David Wolfgang Eberhard Schmidt, Erlangen (DE); Dominic Pascal Schmidt, Erlangen (DE)

Correspondence Address: BRINKS HOFER GILSON & LIONE, P.O. BOX 10395, CHICAGO, IL, 60610, US

(21) Appl. No.: 11/855,464

(22) Filed: Sep. 14, 2007

(51) Int. Cl. G06F 7/06

(52) U.S. Cl. 707/3; 707/104.1; 707/E17.108

(57) ABSTRACT

A search system for searching a secured medical server is provided. The system includes a web-portal and a medical server. The web-portal communicates with a processor and a memory. The processor is operable to communicate with the memory, which is operable to store a medical server password and a medical server location. The medical server includes the medical documents and an access portal. The access portal protects the medical documents in the medical server. The access portal is operable to provide access to the medical documents when provided with the medical server password. The processor is operable to generate and transmit a request signal including a request for information and the medical server password to the healthdata server.

### BACKGROUND

The present embodiments relate to retrieving medical information from a secured medical server. In particular, the present embodiments relate to indexing the retrieved medical information via the Internet and searching the index via the Internet.

A medical server may include private medical information, such as patient conditions, diagnosis guidelines, treatment guidelines, medical facility information, or financial information. The medical information may be retrieved after passing through an access portal of the medical server. The access portal may provide access to medical information in the medical server upon presentation of an authorization code. Accordingly, the medical information in the medical server is not accessible without the proper authorization code.

A traditional search engine spider is not able to access medical information in a secured medical server for at least two reasons. First, the search engine spider may be unable to locate the secured medical server. The medical server may not be connected to the Internet. Search engine spiders use known Internet addresses and links from the known addresses to access unsecured web-pages. Since the medical server may not be connected to the Internet, the spider may not be able to locate the medical server. Second, even if the search engine spider locates the medical server, it can not pass through the access portal. The search engine spider is unable to copy information from the medical server. The search engine index built using information copied by a traditional search engine spider will not include data from secured medical servers. Therefore, a search of the search engine index will not return any results relating to information in the secured medical server.

### SUMMARY

By way of introduction, the preferred embodiments described below include methods, systems, and instructions for searching medical information in a secured healthdata server. The preferred embodiments relate to using an Internet-based search engine to search medical information secured in a healthdata server. A secure credential for access to the healthdata server is incorporated into a search device. The resulting search device may generate a signal that passes through an access portal of the healthdata server using the secure credential. The authorized signal requests medical information, which is copied and transported back to the secure search device. The copied medical information may be stored in the secure search device. A search engine may search the medical information stored in the secure search device via the Internet. The spidered medical information may be organized in a search engine index. Based on the search engine index, a user may search medical information in the healthdata server using the search engine.

In a first aspect, a method for accessing a secured healthdata server includes transmitting a request signal including an access code to the secured healthdata server; providing an access portal securing the healthdata server with the access code; authorizing the request signal based on the access code; and passing the authorized signal through the access portal into the healthdata server.

In a second aspect, a method for searching a secured medical server via the internet includes authorizing a secure search device to access a secured health data server by providing the secure search device with an authorization code, the authorization code being operable to provide access to the secured healthdata server; storing information retrieved from the secured healthdata server in a storage medium; and spidering, with a search engine spider, the storage medium via the internet and using the spidered results to build a search engine index that is operable to be searched via the internet.

In a third aspect, a system for searching secured medical documents includes a web-portal and a medical server. The web-portal communicates with a processor and a memory. The processor is operable to communicate with the memory, which is operable to store a medical server password and a medical server location. The medical server includes the medical documents and an access portal. The access portal protects the medical documents in the medical server. The access portal is operable to provide access to the medical documents when provided with the medical server password. The processor is operable to generate and transmit a request signal including a request for information and the medical server password to the healthdata server.

The present invention is defined by the following claims, and nothing in this section should be taken as a limitation on those claims. Further aspects, embodiments, and advantages of the invention are discussed below in conjunction with the preferred embodiments and may be later claimed independently or in combination.

### BRIEF DESCRIPTION OF THE DRAWINGS

FIG. 1 illustrates one embodiment of a search system.

FIG. 2 illustrates one embodiment of a memory.

FIG. 3 illustrates one embodiment of a configuration report.

FIG. 4 is a flowchart of a method for accessing a secured healthdata server;

FIG. 5 is a flowchart of a method for establishing a trust;

FIG. 6 is a flowchart of a method for accessing a secured healthdata server;

FIG. 7 is a flowchart of a method for transferring information to a secure search device;

FIG. 8 is a flowchart of a method for searching a secured medical server;

FIGS. 9-13 illustrate alternative embodiments of transferred information; and

FIGS. 14-18 illustrate alternative embodiments of secure channels.

### DETAILED DESCRIPTION

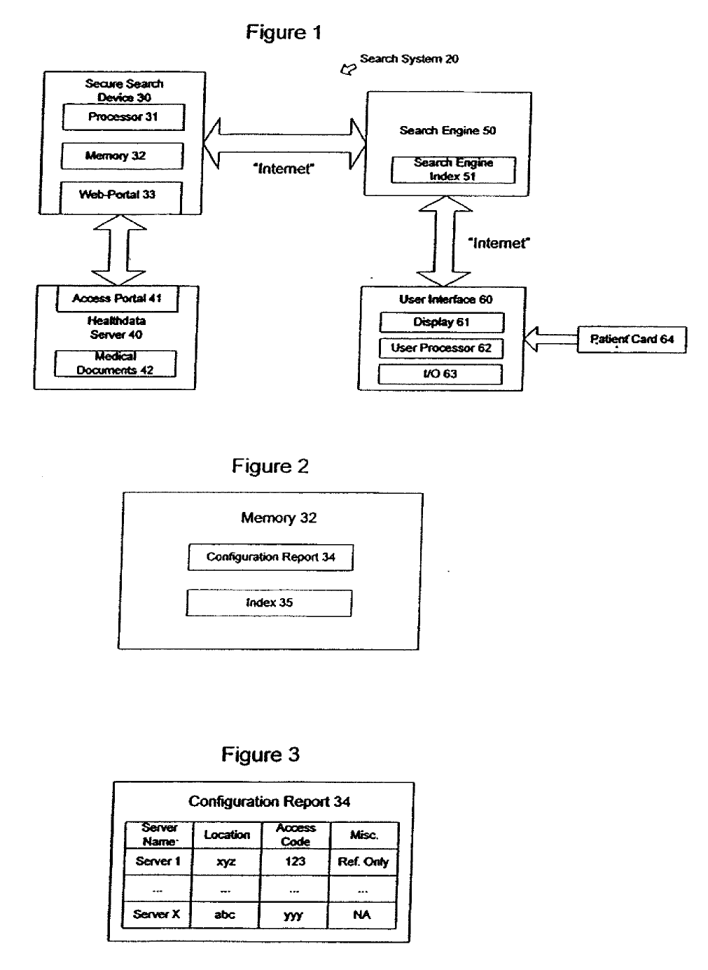

FIG. 1 shows one example of a search system 20 for searching a secured healthdata server 40. The search system 20 includes a search engine 50, a secure search device 30, and a secured healthdata server 40. Additional, different, or fewer components may be provided. For example, as shown in FIG. 1, the search system 20 may include a user interface 60 and/or a patient card 64. The secure search device 30 may communicate with the healthdata server 40 and search engine 50 wirelessly or using dedicated communication lines. For example, the secure search device 30 may send and receive communications via a cable, the Internet, or communication circuits.

The secure search device 30 may include a processor 31, a memory 32, and web-portal 33. Additional, different, or fewer components may be provided. The secure search device 30 operates to retrieve medical information from a healthdata server 40. The secure search device 30 is authorized to retrieve the medical information because a mutual trust is established between the secure search device 30 and the healthdata server 40. For example, the secure search device 30 may be provided with a password to the healthdata server 40.

The secure search device 30 may include a web-portal 33 connected to the Internet. The web-portal 33 includes an address. The web-portal 33 address may be used to navigate to the secure search device 30. The web-portal 33 address may include an internet address, such as a URL://address. The secure search device 30 may receive/transmit communication over the Internet using the web-portal 33. For example, as shown in FIG. 1, the search engine 50 may communicate with the secure search device 30 via the Internet, using an http://, https:// or similar protocol.

The secure search device 30 may include a processor 31. The processor 31 is a general processor, digital signal processor, application specific integrated circuit, field programmable gate array, analog circuit, digital circuit, combinations thereof or other now known, or later developed processor. The processor 31 may be a single device or a combination of devices, such as associated with a network or distributed processing. Any of various processing strategies may be used, such as multi-processing, multi-tasking, parallel processing or the like. The processor 12 is responsive to instructions stored as part of software, hardware, integrated circuits, firm-ware, micro-code, or the like. The processor 31 may be adjacent to, part of, networked with and/or remote from a storage medium.

The processor 31 operates to generate a retrieval signal. The retrieval signal may be sent to a healthdata server 40. The retrieval signal may include requested information, an access credential, transmitting restrictions, or a combination thereof.

The retrieval signal may include a request for information. The requested information may include information needed by the secure search device 30, the search engine 50, or a medical user. For example, the processor 31 may analyze information needed based on a request from the search engine 50, an index being built in the secure search device 30, a user request over a secure channel, or other similar needs. The information needed may include any information stored in healthdata server, such as medical data relating to a patient, information in a medical ontology, medical guidelines, facility information, financial records, or any combination thereof. The retrieval signal is used to request the needed information from the healthdata server.

The retrieval signal may include an access credential. The processor 31 analyzes the healthdata server address that the retrieval signal is being sent to and determines the access credential required to pass through the access portal securing the healthdata server 40. For determining the access credential, the processor 31 may analyze a configuration report. For example, the processor 31 ensures that the correct access credential is sent to the healthdata server 40.

The secure search device 30 operates to transmit the retrieval signal to the healthdata server 40. For example, the retrieval signal may be transmitted over a cable, the Internet, or another communication device. The secure search device 30 may transmit one retrieval signal to the healthdata server 40. For example, the processor 8 may include the access credential and the request for information in the same retrieval signal. In another example, the processor 8 may transmit independent signals for each the access credential and the request for information.

The secure search device 30 may include a memory 32. The memory 32 is a readable storage media. For example, a computer may read the memory 32. The memory 32 may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 32 may be a single device or a combination of devices.

As shown in FIG. 2, the memory 32 may store a configuration report 34. For example, a spreadsheet of healthdata server addresses, access credentials, transportation commands, communication restrictions, or the like may be stored. The configuration report 34 may be altered, replaced, or eliminated from the memory 32. A computer, processor, or user interface may be connected to the secure search device 30 to alter, replace, or eliminate the configuration report 34.

As shown in FIG. 3, the configuration report may include healthdata server names and addresses, access credentials, transmitting restrictions, or other retrieval instructions. For example, the configuration report may include a transmitting restriction that limits the type of information transmitted from the healthdata server, such as a reference, encryption, or patient pseudonym. In another example, the configuration report includes different user names and access credentials for the same healthdata server. Multiple user names and access credentials may be provided for the same healthdata server.

As shown in FIG. 2, the memory 32 may store an index 35. The index 35 may include medical information retrieved from a healthdata server 40. The processor 31 may analyze the retrieved medical information and organize the information according to a classification or sub-classification of medical information. For example, the index 35 may be organized based on patient-related information, such as a patient identification ID, a key derived from the patient identification ID, or suitable patient demographics. A patient-related information index may be used to create patient-specific electronic records (EHRs) or temporary patient-specific views for possible further processing. Alternatively, the index 35 may be organized based on medical topics, such as domains, classes, sub-classes, or concepts in a medical ontology. An example medical ontology is SNOMED CT, or the like. The index 35 may also be organized based on patient-related information and medical topics.

The memory 32 may be accessed by the processor 31 and web-portal 33. For example, the processor 31 may organize information from healthdata server 40 and communicate the information to the memory 32. In another example, the search engine 50, a search engine spider, the user interface 60, or other devices may access the memory 32 via the web-portal.

The healthdata server 40 may include an access portal 41, medical documents 42, and an address. Additional, different, or fewer components may be provided. The healthdata server 40 operates to protect medical documents. For example, medical documents may only be accessed, retrieved, or copied after passing through the access portal 41.

The healthdata server 40 has a healthdata server address. The healthdata server 40 may be accessed, located, or identified by the healthdata server address. The secure search device 30 may communicate with the healthdata server 40 using the server address. For example, a retrieval signal may be transmitted from the secure search device 30 to the healthdata server 40. In another example, a medical professional or patient may navigate to the healthdata server 40 using the healthdata server address. In another example, a secure channel may be established between a medical professional and patient using the healthdata server address. In another example, the healthdata server 40 includes the secure search device 30. In an alternate embodiment, the secure search device 30 and the healthdata server 40 have the same address and may be connected by a cable or communication circuit. For example, the healthdata server 40 may include the secured search device 30.

The healthdata server address may include an Internet address, server address, or network address. For example, the Internet address may be a URL://address. Any communication device may communicate with the healthdata server 40 using the server address. For example, the user interface 60 may use the server address to communicate with the healthdata server 10.

The healthdata server 40 may include an access portal 41. The access portal 41 secures information in the healthdata server 4. The access portal 41 may be configured to allow access upon a presentation of an access credential. For example, the access portal 41 may deny access to the information in the healthdata server 40 when the access credential is not provided. Information in the healthdata server 40 may be accessed only after “passing through” the access portal 41. For purposes of the access portal 41, “passing through” requires a presentation of an access credential that the access portal has been configured to authorize. The access portal 41 may be configured to add to, subtract from, or change the required access credential. For exemplary purposes, the access credential may be considered a “key” and the access portal a “lock.” If the lock is changed, the key must also be changed. A computer or interface may be used to configure the access portal 41. The healthdata server provider may distribute the new access credential to trusted secure search devices. This distribution establishes a trust between the secure search device and the healthdata server.

The access credential may include a single code. For example, a single word, 8-bit signal, or similar code may be used for the access credential. Alternatively, the access credential includes more than one code. For example, the access credential may include a user identification and password. The user identification may be used to record different users that attempt to gain access through the access portal 41. The password may be used to verify authorization of the request signal.

The healthdata server 40 may include medical documents 42. The medical documents 42 include medical information, such as patient identifiers, patient-related medical data, medical markups, patient-related information, or the combination thereof. The medical documents 42 are stored in one or more medical databases. For example, x-ray images may be stored in an x-ray database, clinical guidelines may be stored in a guideline database, and patient-related medical conditions may be stored in a medical conditions database.

The healthdata server 40 may locate requested information in the medical documents 42. The healthdata server 40 scans the medical documents and identifies requested information. The healthdata server 40 may also locate information that relates to the requested information, such as a semantic term. The semantic term may be located using an ontology or other classification system. The healthdata server 40 may also locate medical information in other healthdata servers connected in a network. For example, a hospital may use a healthdata server 40 to record, store, or address medical records. The hospital may mutually agree with one or more hospitals, which also use healthdata servers, to create a network of healthdata servers. The healthdata servers on the network can communicate or share medical information with other network healthdata servers.

The healthdata server 40 may disguise or alter located information. For at least security reasons, the healthdata server 40 may disguise or alter the located information before transmitting to the secure search device 30. The healthdata server 40 may determine whether to disguise the located information and which disguise to use. For determining, the healthdata server 40 may analyze the retrieval signal or the information being transmitted. For example, the retrieval signal may include transmitting restrictions that instruct the healthdata server 40 to disguise the requested information a certain way. Such instructions may be recorded in a configuration report. The retrieval signal may also include instructions on which disguise to use. For example, the healthdata server 40 may be instructed to encrypt information sent to the secure search device 30. Alternatively, the healthdata server 40 may analyze the information being transmitted and determine whether the information should be disguised. For example, a private medical condition, such as cancer, may be transmitted with a patient identifier. Based on an analysis of this information, the healthdata server 40 may determine that one or both of the patient identifier and the medical condition should be disguised.

As a disguise, the healthdata server 40 may pseudomyze or encrypt information. The healthdata server 40 may operate to pseudomyze information by assigning a codified number, alphabetic word, or the combination to the information. The healthdata server 40 may de-pseudomyze the information. For example, the healthdata server 40 may de-pseudomyze the information when patient credentials are provided to the healthdata server 40. Alternatively, or in combination with pseudomyzing information, the healthdata server 40 may encrypt information. The encrypted information includes a secret code that may be decrypted with the proper authorization, such as a key, password, logic, or the like.

As a disguise, the healthdata server 40 may generate a reference REF to medical data EMD in the healthdata server 40. The reference REF may identify the location of the medical data EMD in the healthdata server 40. For example, the reference REF may include an Internet address, server address, or network address of the medical data EMD. A user may navigate to the address of the medical data EMD using the reference REF and view the medical data EMD. The user may be required to provide additional patient credentials to access the healthdata server 40. For example, the patient may be required to pass through an access portal 41 of the healthdata server 40 before viewing the medical information.

The search engine 50 may “spider” the secure search device 30 via the Internet. For example, the search engine 50 may locate the web-portal 33 and copy information from the secure search device 30, the index 35, or the memory 32. To locate the web-portal 33, the spider may use known addresses, addresses or links found at a known address, or other known spidering techniques. The copied information is returned to the search engine 50 and stored in a search engine index 51, which may be stored in a memory.

The user interface 60 may be used to search the search engine index 51 via the Internet. The user interface 60 may include a display 61 that displays information to a user. The user may input a “search term” that is transferred to a user processor 62 of the user interface 60. The user processor 62 generates a query signal that is sent to the search engine 50 via the Internet. The query signal may include a request for information relating to the search term. Based on the query signal, the search term, semantic terms, and other related results are located in the search engine index 51 and returned to the user interface 60. Other information may be returned, such as only a portion of the actual information from which the term was extracted or identified. The search engine 50 may include a reference to the actual address of the copied information. For example, the user may select a result and be directed to the actual location of the information. The user may be required to input a set of credentials that verify authorization to view the material in the healthdata server 40.

The search system 20 may include a patient card 64. The patient card 64 may be connected to the input/output 63 of the user interface 60. The patient card 64 may store personal credentials about the patient, such as patient specific credential used to resolve a pseudonym or patient identifier information used for a search. For example, the patient specific credential may be used to redo the pseduonymization with an additional function of the healthdata server 40 that translates the patient identification PID in the pseudonym. The patient card 64 may include, for example, a data card that stores data, a smart card that stores data and processes the data, a card that accesses personal patient information from a remote location, or a similar card. A smart card may be used to establish a secured channel between the user interface 60 and the secured search device 30 and/or healthdata server 40. The secure channel may be used to communicate with the other devices. For example, medical information may be transmitted over the secured channel. The secure channel is established by confirming communication sent by the smart card.

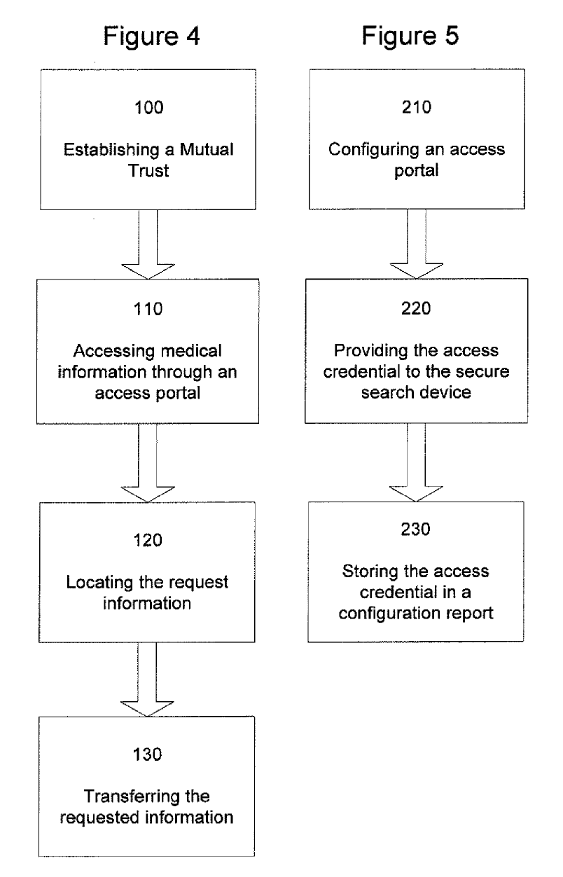

FIG. 4 shows a method for accessing a secured healthdata server. The method is implemented using the system 1 of FIG. 1 or a different system. Additional, different or fewer acts than shown in FIG. 4 may be provided. For example, act 120 may not be performed. In another example, only acts 100 and 110 are performed. The acts are performed in the order shown or a different order. The acts may be performed automatically, manually, or combinations thereof.

In act 100, a mutual trust is established between the secure search device 30 and the healthdata server 40. A mutual trust is established by providing the secure search device 30 with an access credential to the healthdata server 40. For example, the healthdata server 40 may provide the secure search device 30 with an authorization code, password, access credential, or other substantially secret element. Access to the healthdata server 40 may be limited to a certain number of users, trusted users, or no users based on the discretion of the healthdata server 40.

FIG. 5 shows an expanded flow chart for one exemplary embodiment of act 100. In act 210, the access portal 41 of the healthdata server 40 is configured to provide access upon confirmation of a certain access credential. In act 220, the access credential is provided to the secure search device 30. For example, the access credential may be provided to the secure search device 30 by communications between the providers of secure search device 30 and the healthdata server 40. As another example, the credential is downloaded or programmed into the secure search device 30 by a user. In act 230, the access credential is stored in a configuration report 34 or other location. The access credential may include a user identification and password. The healthdata server 40 may identify the users attempting to access the access portal 41.

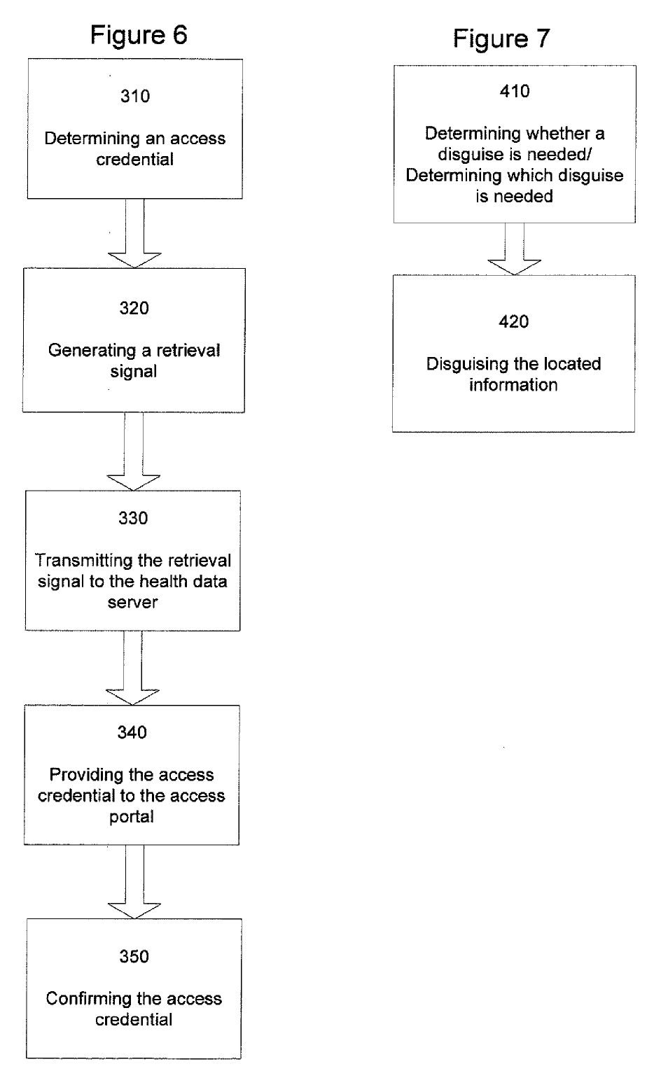

Referring again to FIG. 4, in act 110, the secure search device 30 accesses secured medical data through an access portal 41 of the healthdata server 40. The secure search device 30 communicates with the healthdata server 40 through the access portal 41. For example, FIG. 6 is an expanded flow chart for one exemplary embodiment of act 110. In act 310, a processor 31 of the secure search device 30 generates a retrieval signal, which includes a request for information. In act 320, the processor 31 determines an access credential for the healthdata server 40 to which the query is being sent. The processor 31 determines the access credential based on a configuration report 34. In act 330, the processor 31 transmits the retrieval signal including the access credential of the access portal 41 of the healthdata server 40. In act 340, the access credential is provided to the access portal 41. In act 350, the access portal 41 confirms the access credential.

In act 120, as shown in FIG. 4, the healthdata server 40 locates the requested information. Locating the information may include identifying the requested information. The located information may be compiled from a plurality of medical documents 42. The medical documents 42 may be found in one or more network healthdata servers. For example, the requested information may be located in one or more hospital servers in a network.

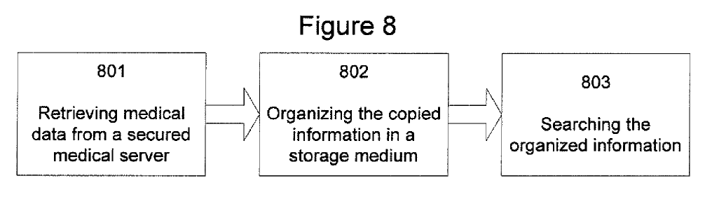

In act 130, the requested information is transferred to the secure search device 30. The information may be transferred in real-time, for example, as the requested information is located, or after the healthdata server 40 finishes locating information. The information may be secured for transferring. For example, FIG. 7 shows an expanded flow chart for one exemplary embodiment of act 130.

In act 410, the healthdata server 40 determines whether the information located in the healthdata server 40 should be altered. For determining, the healthdata server 40 may analyze the user identification, information being transmitted, the distance or type of communication line between the healthdata server 40 and the secure search device 30, or other security concerns. For example, the healthdata server 40 may transfer the requested information without heightened security measures. The information, whether secured or unsecured, is transferred to the secure search device 30.

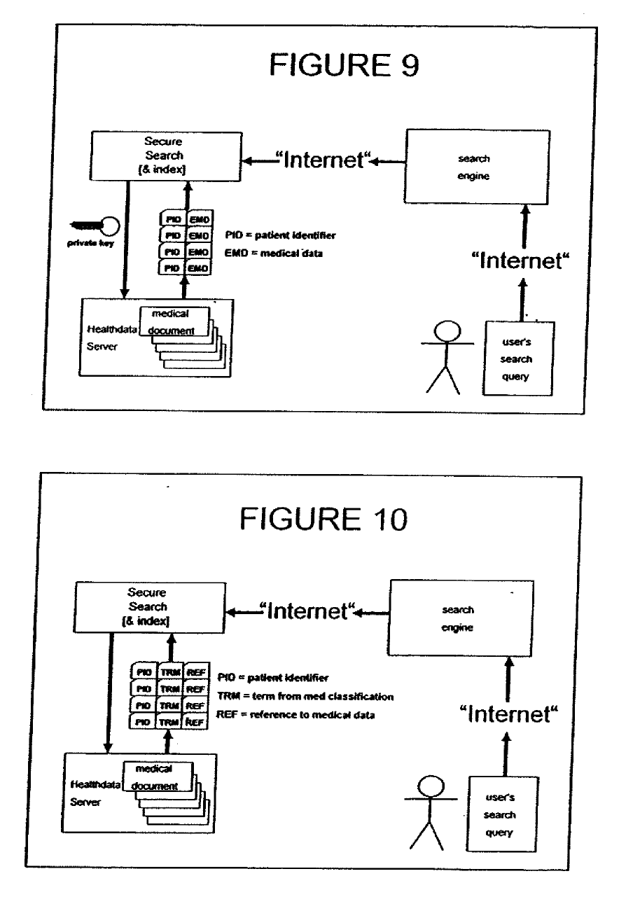

In one embodiment, the located information is transferred to the secure search device 30 without securing the information. For example, as shown in FIG. 9, the located information may include a patient identifier PID and medical data EMD. The patient identifier may include a name, number, or other mark that identifies the patient. The medical data may include patient-related information about medical conditions, guidelines, or medical related information. For example, the patient-related information may include a resting heart rate, blood pressure, or other treatment procedures. The patient identifier PID and medical data EMD is transferred to the secure search device 30. As shown in FIG. 9, a plurality of patient identifiers PID and corresponding medical data EMD may be transferred to the secure search device 30. For example, the secure search device 30 may request medical data EMD corresponding to all, some, or none of the patient identifiers PID located in the healthdata server 40.

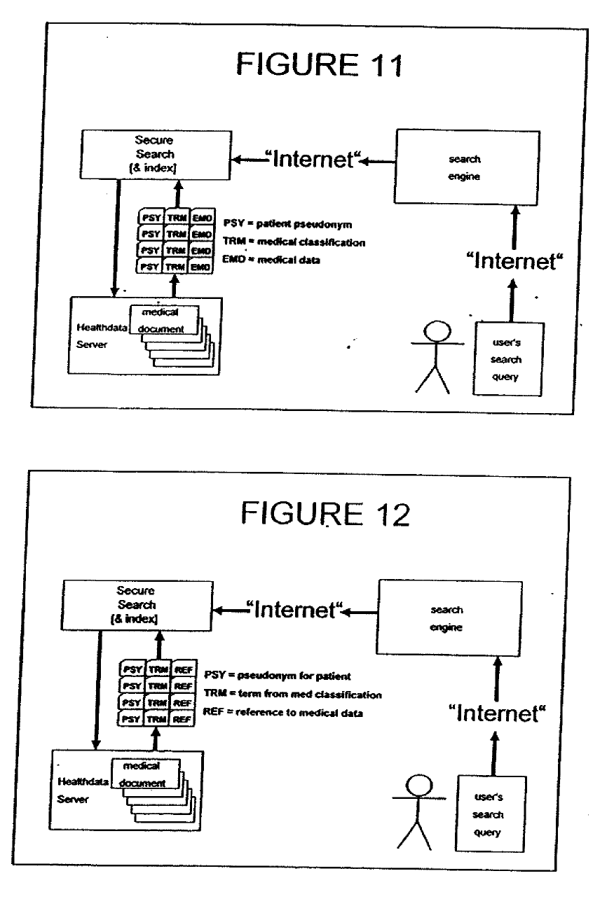

In act 420, the healthdata server 40 alters the located information and transfers the information to the secure search device 30. In one embodiment, a disguised patient identifier is transferred to the secure search device 30. The healthdata server 40 may disguise the patient identifier PID. For example, the healthdata server 40 may pseudomyze, encrypt, or manipulate the patient identifier PID. The disguise protects the patient's identity. As shown in FIG. 11, the healthdata server 40 may generate a patient pseudonym and transfer the pseudonym to the secure search device 30. Alternatively, the healthdata server 40 may encrypt a patient identifier and transfer the encryption to the secure search device 30. The healthdata server 1 may transfer a disguised patient identifier with other related information, such as medical data EMD, semantic markings TRM, or the combination thereof. A semantic marking TRM is related to the requested information. The semantic marking may be identified using a medical domain, ontology, physician notes, or other medical classification.

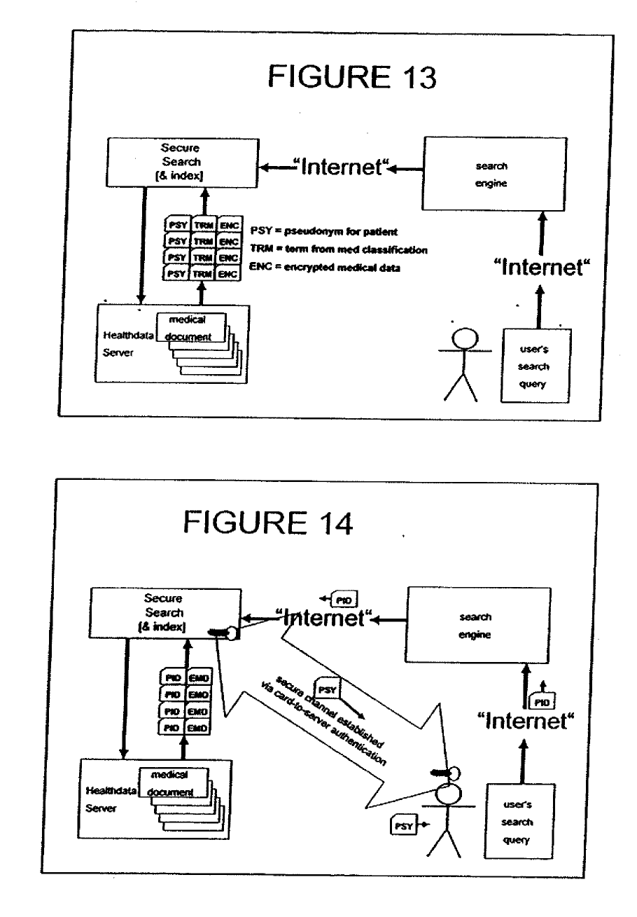

In one embodiment, altered or protected medical data is transferred to the secure search device 30. For example, the healthdata server 40 may encrypt the medical data EMD. The encrypted medical data ENC protects the patient's medical data EMD. As shown in FIG. 13, the healthdata server 40 may generate encrypted medical data ENC and transfer the encrypted medical data ENC to the secure search device 30. The encrypted medical data ENC may be transferred with a patient identifier PID, either disguised or not disguised; a semantic term TRM; or the combination thereof.

In one embodiment, a reference to medical data is transferred to the secure search device 30. The reference REF identifies a location of medical data EMD. The healthdata server 40 may generate a reference REF and transfer the reference REF to the secure search device 30. The reference REF may be transferred with other located, processed, or disguised information. For example, as shown in FIG. 10, a patient identifier PID and a reference REF are transferred to the secure search device 30. In another example, as shown in FIG. 12, a patient pseudonym PSY and reference REF are transferred to the secure search device 30. In another example, the reference REF may be transferred with a semantic term TRM.

In one embodiment, a secure channel may be established directly between the user interface 60 and the secure search device 30 or the healthdata server 40. The secure channel may be established by connecting a patient card (e.g. a smart card) 64 into an input/output 20 of the user interface 60. The patient card 64 request confirmation from the secure search device 30 or the healthdata server 40 via a communication connection, such as a cable, the internet, or other communication device. The secure search device 30 or the healthdata server 40 responds with a confirmation signal that may be confirmed by the patient card 64. Upon confirmation, a secure channel is established between the communicating devices.

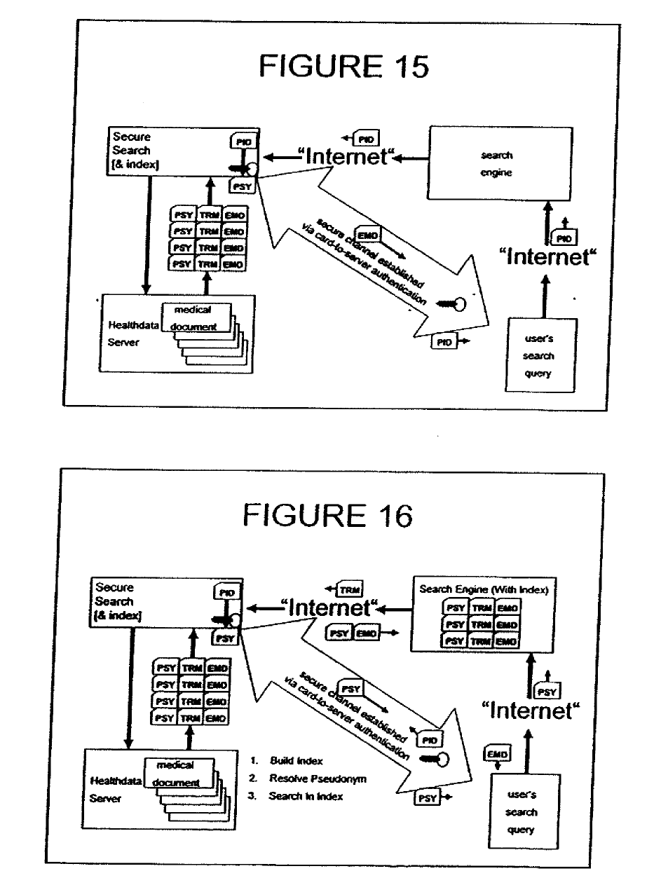

In one embodiment, a secure channel may be established between the patient card 64 and the secure search 5. The secure channel is an Internet secure channel, such as SS7. Medical information may be transmitted over the secure channel. For example, as shown in FIG. 14, the secure search device 30 may transmit medical data EMD over the secure channel to the user interface 60. The patient card 64 may be used to transmit the patient identifier PID to the secure search device 30. The secure search device 30 may use the patient identifier PID to locate the medical data EMD. In another embodiment, as shown in FIG. 15, the secure search device 15 may use the patient identifier PID to resolve the patient pseudonym PSY. The medical data EMD corresponding to the patient identifier PID is then sent via the secure channel. In another example, the patient card 64 transmits a patient identifier PID to the secure search device 30. The secure search device 30 returns a patient pseudonym PSY to the patient card 64. The patient card 64 uses the patient pseudonym PSY to search a search engine index 51 in a search engine 50. The search engine 50 transmits the corresponding medical data EMD to the patient card 64.

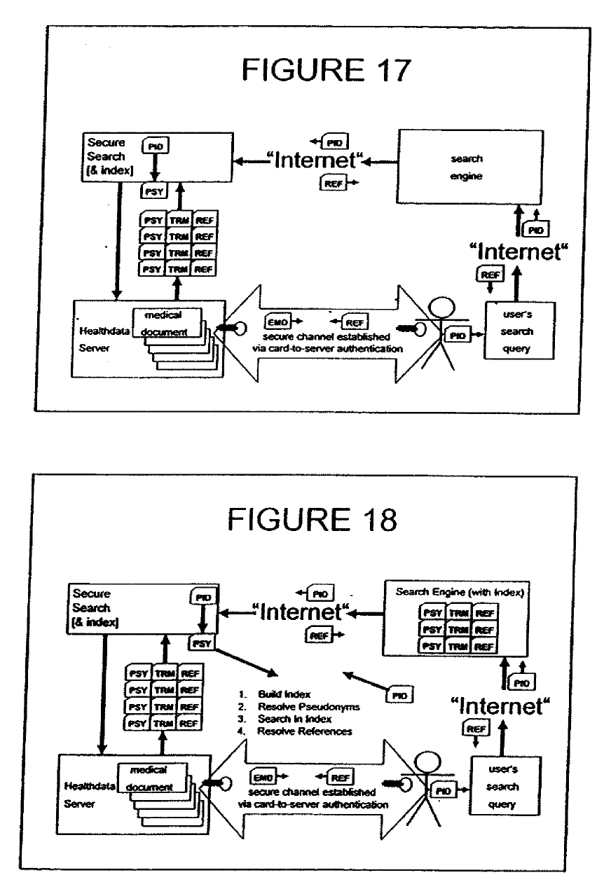

In one embodiment, a secure channel may be established between the patient card 64 and the healthdata server 40. Medical information may be transmitted over the secure channel. For example, as shown in FIG. 17, a patient card 64 may receive a reference REF to medical data EMD in the healthdata server 40. The patient card 64 may transmit the reference REF and a patient credential from the patient card 64 to the healthdata server 40 via the secure channel. The healthdata server 40 may transmit the corresponding medical data EMD via the secure channel. In another example, as shown in FIG. 18, a patient identifier is transmitted to the secure search device 30. In return, the secure search device 30 transmits a patient pseudonym PSY to the patient card 64. The patient card 64 searches a search engine index 51 for the patient pseudonym PSY. The search engine 50 transmits a reference REF to the patient card 64. Using the reference REF, as discussed above, the patient card 64 accesses the patient's medical data EMD via the secure channel.

FIG. 8 shows a method for searching a secured healthdata server 40 using a search engine. The method is implemented using the system 1 of FIG. 1 or a different system. Additional, different or fewer acts than shown in FIG. 8 may be provided. The acts are performed in the order shown or a different order. The acts may be performed automatically, manually, or combinations thereof.

In act 801, a secure search retrieves medical data from a healthdata server 40 requiring an authorization code for access. A communication device may use a request signal to retrieve information from the secured healthdata server 40. The request signal may include requested information and an authorization code, which is configured to provide access to the healthdata server 40. The authorization code is provided to the communication device from a healthdata server authorized personal, such as the server manager, a hospital president, or network manager. The request signal is transferred to the healthdata server 40. The request signal is granted access to the healthdata server after providing the authorization code. Based on the requested information, the healthdata server copies the requested information. The copied information may be transferred to a storage medium.

In act 802, the retrieved information is organized in a storage medium. The copied information may be grouped according to a medical classification. For example, the copied information may be organized based on a medical ontology or medical domain. The copied information may include a link to the location of the actual information in the healthdata server 40.

In act 803, an Internet-based search engine 50 copies information from the storage medium. The Internet-based search engine generates a search engine index 51 using the copied information. The copied information may include medcial information, encrypted medical information, patient pseudonyms, references to medical information, or similar information. A search term may be transferred from a computer to a search processor that searches the organized information in the storage medium for the search term. The processor may search the organized information by comparing the search term, relevant terms, or semantic terms to the copied information in the storage medium. The processor returns the search results to the computer.

While the invention has been described with reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A method for accessing a secured healthdata server; the method comprising:
transmitting a request signal including an access code to the secured healthdata server;
providing an access portal securing the healthdata server with the access code;
authorizing the request signal based on the access code; and
passing the authorized signal through the access portal into the healthdata server.

2. The method according to claim 1, wherein the access code includes a user identification and password.

3. The method according to claim 1, wherein the request signal includes a request for information.

4. The method according to claim 3, comprising:
locating the requested information in the healthdata server; and
transmitting a copy of the located information from the healthdata server to a storage medium.

5. The method according to claim 4, comprising:
organizing the transmitted information in an index of the storage medium.

6. The method according to claim 5, comprising:
spidering, with a search engine, the index.

7. The method according to claim 4, comprising:
securing the located information before transmitting the located information to the healthdata server.

8. The method according to claim 7, wherein securing the located information includes pseudonymizing, with the healthdata server, the located information.

9. The method according to claim 7, wherein securing the located information includes encrypting, with the healthdata server, the located information.

10. The method according to claim 4, comprising:
generating, with the healthdata server, a reference to medical data in the healthdata server.

11. The method according to claim 10, wherein transmitting the copied data includes transmitting the reference to medical data.

12. The method according to claim 4, comprising:
establishing a secured channel between a patient card and the secured search device, wherein the secured channel is operable to transmit medical information.

13. The method according to claim 4, comprising:
establishing a secured channel between a patient card and the healthdata server, wherein the secured channel is operable to transmit medical information.

14. The method according to claim 1, comprising:
establishing a mutual trust between a secured search device and a healthdata server, wherein an access code is provided to the secure search device.

15. The method according to claim 5, wherein the index is organized based on a medical ontology.

16. A method for searching a secured medical server via the internet; the method comprising:
authorizing a secure search device to access a secured health data server by providing the secure search device with an authorization code, the authorization code being operable to provide access to the secured healthdata server;
storing information retrieved from the secured healthdata server in a storage medium; and
spidering, with a search engine spider, the storage medium via the internet and using the spidered results to build a search engine index that is operable to be searched via the internet.

17. The method according to claim 16, wherein the retrieved information is retrieved from the secured healthdata server by transmitting a request signal, which includes the authorization code and a request for information, from the secure search device to the healthdata server.

18. The method according to claim 17, comprising:
locating, using the healthdata server, the requested information; and
securing, using the healthdata server, the located information.

19. A system for searching secured medical documents, comprising:
a web-portal in communication with a processor and a memory, the processor being operable to communicate with the memory that is operable to store a medical server password and a medical server location;
a medical server that includes the medical documents and an access portal that protects the medical server, the access portal operable to grant access to the medical documents when provided with the medical server password,
wherein the processor is operable to generate and transmit a request signal including a request for information and the medical server password to the healthdata server location.

20. The system according to claim 19, comprising:
a search engine operable to spider the memory and organize the spidered results into a search engine index.
